(19) United States
(12) Patent Application Publication
(10) Pub. No.: US 2009/0044686 A1
(43) Pub. Date: Feb. 19, 2009

(54) SYSTEM AND METHOD OF USING METADATA TO INCORPORATE MUSIC INTO NON-MUSIC APPLICATIONS

(76) Inventor: Yojak H. Vasa, Cary, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/838,326

(22) Filed: Aug. 14, 2007

(51) Int. Cl. G10H 7/00

(52) U.S. Cl. 84/609

(57) ABSTRACT

A system and method are provided for incorporating music into other, non-music applications of an electronic device. The metadata of music files on an electronic device may be searched according to specified search criteria. The metadata search identifies matching music that would be appropriate to play while using, or incorporate into, a non-music application. If the metadata search indicates that the mobile device does not have stored in memory an appropriate matching music file, then the user may be directed to a server or other location on a communications network that stores music files. The user may then download or stream the music files whose metadata matches the search criteria from the network for incorporation into the non-music application. In one exemplary embodiment, the non-music application is a video game, and the game program searches music metadata to find one or more music files in which the musical style matches the style of game play

### TECHNICAL FIELD OF THE INVENTION

The technology of the present disclosure relates generally to portable electronic devices, and more particularly to a portable electronic device that uses music metadata to incorporate music into a non-music application.

### DESCRIPTION OF THE RELATED ART

Portable electronic devices commonly have the capability to play music. Although a user may listen to music independent of other device functions, often the device would be more enjoyable if the user could incorporate music into other, non-music applications. There currently appears to be no convenient method to incorporate music into non-music applications to permit a user to customize, and therefore enhance enjoyment of, non-music applications.

Portable electronic devices, such as mobile telephones, media players, personal digital assistants (PDAs), and others, are ever increasing in popularity. To avoid having to carry multiple devices, portable electronic devices are now being configured to provide a wide variety of functions. For example, a mobile telephone may no longer be used simply to make and receive telephone calls. A mobile telephone may also be a camera, an Internet browser for accessing news and information, an audiovisual media player, a messaging device (text, audio, and/or visual messages), a gaming device, a personal organizer, and have other functions as well.

With regard to music player functionality, a user may download music files over the Internet or other communications network and store the downloaded files within memory in the device. Music files also may be streamed to the device, either from a recorded source or from a live broadcast or feed.

Regardless of how a music file is received in an electronic device, the music file typically contains associated “metadata” information. Generally, metadata may be thought of as digital data providing information about other digital data or files. For example, when one takes a picture with a digital camera, metadata associated with the picture file may include such information as the date and time the picture was taken, the file size, an identifier (such as a title, file name, or number), and/or other items of information about the picture. Document files, video files, emails, and other file types similarly may contain metadata that provides various information about the associated files. The metadata may be contained within XML descriptive fields within the file.

Like other digital data files, digital musical files typically contain metadata information about the music file. For example, the metadata may include the song title, genre, artist, beats per minute, length, common instruments, and other items of information that describe aspects of the music. When digital music is conveyed over networks or by digital broadcasts, certain items of metadata are commonly included within the music files, such as title, artist, and beats per minute. If one possesses the metadata, the metadata may be used as a basis for searching for the substantive music or song. For example, publicly accessible services such as the Compact Disc Database (CDDB) or GraceNotes may be used to match metadata with an associated substantive music file. There also exist applications or programs that permit a user to define and customize metadata. For example, a user may wish to add a metadata field to describe a category or “mood” to be associated with one or more music files to customize or organize songs into personal groupings, such as party music, relaxation music, travel music, or others.

Music may be included in various functions or applications of portable electronic devices. For example, music is typically incorporated into video games. The use of portable electronic devices as gaming devices has increased dramatically in recent years. Some portable electronic devices have been developed primarily for gaming, but gaming is now often incorporated as one function in a multi-function portable electronic device. For example, mobile telephones often may be used to play video games. Games may be downloaded to a mobile telephone and stored in memory, or played over a communications network or the Internet.

Although the incorporation of music into video games is common, the quality of sound of the music may be deficient, particularly if the games are developed for and played on portable electronic devices, like mobile telephones, that are not intended primarily for gaming. Because gaming capabilities of mobile telephones may be restricted by such things as the permissible file size and processor capabilities, music in mobile telephone games often is created in a low quality format. For example, the music may be delivered in a low quality Music Instrument Digital Interface (MIDI) format. The quality of music in mobile games, therefore, typically is far inferior to the quality when one simply listens to a downloaded or streamed song.

Another deficient aspect of music in mobile telephone gaming is that the music typically is not customizable by the user. Rather, the music may be incorporated into the game by the game developer in an unalterable form.

### SUMMARY

To improve the consumer experience with electronic devices, there is a need in the art for an improved system and method for incorporating music into other, non-music device applications. In exemplary embodiments of the present invention, the metadata of music files on an electronic device is searched according to specified search criteria. The metadata search identifies matching music that would be appropriate to play while using, or incorporate into, a non-music application. If the metadata search indicates that the mobile device does not have stored in memory an appropriate matching music file, then the user may be directed to a server or other location on a communications network that stores music files. The user may then download or stream the music files whose metadata match the search criteria from the network. In one exemplary embodiment, the non-music application is a video game, and the game program searches music metadata to find one or more music files in which the musical style matches the style of game play.

Therefore, according to one aspect of the invention, a system for selecting music for use in an electronic device includes a media player within the electronic device, a storage device for storing a plurality of music files wherein each of the music files has associated metadata, and a controller for executing an application by the electronic device, wherein the controller is configured to search the metadata of the music files for metadata that matches search criteria for selecting music to play during execution of the application, and wherein the controller is further configured to cause the media player to play at least one music file for which the associated metadata matches the search criteria while executing the application.

According to one embodiment of the system, the storage device is memory located within the electronic device.

According to one embodiment of the system, the storage device is a server external to the electronic device.

According to one embodiment of the system, the controller is within the electronic device.

According to one embodiment of the system, the controller is within a server external to the electronic device.

According to one embodiment of the system, the device application is a video game.

According to one embodiment of the system, the search criteria for searching the music metadata include at least one of the song title, artist, beats per minute, genre, or mood.

According to one embodiment of the system, the electronic device is a mobile telephone.

Another aspect of the invention is a method of using music in an application of an electronic device that includes the steps of storing a plurality of music files in a storage device wherein each of the music files has associated metadata, setting search criteria for searching the music metadata to select music for playing during execution of the application, searching the music metadata of the plurality of music files to select at least one music file for which the associated metadata matches the search criteria, and executing the application, wherein a music file for which the associated metadata matches the search criteria is played while the application is executed.

According to one embodiment of the method, the storing step includes storing a first plurality of music files within a first storage device located within the electronic device, and the searching step includes searching the music metadata of the first plurality of music files to select at least one music file for which the associated metadata matches the search criteria.

According to one embodiment of the method, the storing step includes storing a second plurality of music files within a second storage device located external to the electronic device, and the searching step includes, if a matching music file is not selected from the first storage device, searching the second plurality of music files on the second storage device to select at least one music file for which the associated metadata matches the search criteria.

According to one embodiment of the method, the method further includes downloading the at least one matching music file from the second storage device to the electronic device.

According to one embodiment of the method, the method further includes streaming the at least one matching music file from the second storage device to the electronic device.

According to one embodiment of the method, the application includes a plurality of components, and the method is performed as to each of the plurality of components.

According to one embodiment of the method, the search criteria for searching the music metadata include at least one of song title, artist, beats per minute, genre, or mood.

According to one embodiment of the method, the application is a video game.

According to one embodiment of the method, the electronic device is a mobile telephone.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of a mobile telephone as an exemplary electronic device for use in accordance with an embodiment of the present invention.

FIG. 2 is a schematic block diagram of operative portions of the mobile telephone of FIG. 1.

FIG. 3 is a schematic diagram that represents portions of a typical music file.

FIG. 4 is a flowchart depicting an exemplary method that may be used in accordance with an embodiment of the present invention.

FIG. 5 is a schematic diagram of an exemplary game application that may be used in accordance with an embodiment of the present invention.

FIG. 6 is a schematic diagram of an exemplary system for incorporating music into a game application in accordance with an embodiment of the present invention.

FIG. 7 is a schematic diagram of a communications system in which the mobile telephone of FIG. 1 may operate.

FIG. 8 is a schematic diagram of operative portions of an exemplary music selection server that may be used in accordance with an embodiment of the present invention.

FIG. 9 is a flowchart depicting another exemplary method that may be used in accordance with an embodiment of the present invention.

### DETAILED DESCRIPTION OF EMBODIMENTS

The present invention provides the user with a system and method for customizing music for use in non-music applications of an electronic device. In an exemplary embodiment, music may be incorporated as an integral part of a video game application by matching music with the particular style of game play of the video game. By permitting the user to customize music for use with the video game application, the user may attain enhanced enjoyment of the game.

Embodiments of the present invention provide a system and method for using metadata in music files to match music for incorporation into a non-music application. The portable electronic device, a server on a communications network, or a non-music application itself may include an application or program feature to search the metadata of music files stored either in a memory in the portable electronic device or on a network server external to the electronic device. The parameters of the search may be defined by XML metadata fields, such as song title, artist, beats per minute, or other. In one exemplary embodiment, the non-music application may be a video game, and the video game program searches the metadata of music files to identify music in which the musical style matches the style of game play.

In one embodiment, if the metadata search reveals that the mobile device does not contain in an internal memory any music files that match the search criteria, then the user may be offered matching music through a music service external to the mobile device. For example, the user may be connected to a server on the Internet or other communications network that offers music downloads, streaming audio, or live broadcasts or feeds. A user may then select music that matches the criteria of the metadata search.

In this manner, music may be incorporated into a non-music application. Because the music file is created independent of the non-music application prior to incorporation therein, the music file would tend to be of a higher quality than if the music were programmed as part of the application initially. In addition, because the music may be selected by the user based on set search criteria, the music may be customized to the user's tastes, which also enhances enjoyment of the non-music application.

Embodiments of the present invention will now be described with reference to the drawings, wherein like reference numerals are used to refer to like elements throughout. It will be understood that the figures are not necessarily to scale.

The following description is made in the context of a conventional mobile telephone. It will be appreciated that the invention is not intended to be limited to the context of a mobile telephone and may relate to any type of appropriate electronic device, examples of which include a media player, a gaming device, or a desktop or laptop computer. For purposes of the description herein, the interchangeable terms “electronic equipment” and “electronic device” also may include portable radio communication equipment. The term “portable radio communication equipment,” which sometimes hereinafter is referred to as a “mobile radio terminal,” includes all equipment such as mobile telephones, pagers, communicators, electronic organizers, personal digital assistants (PDAs), smartphones, and any communication apparatus or the like.

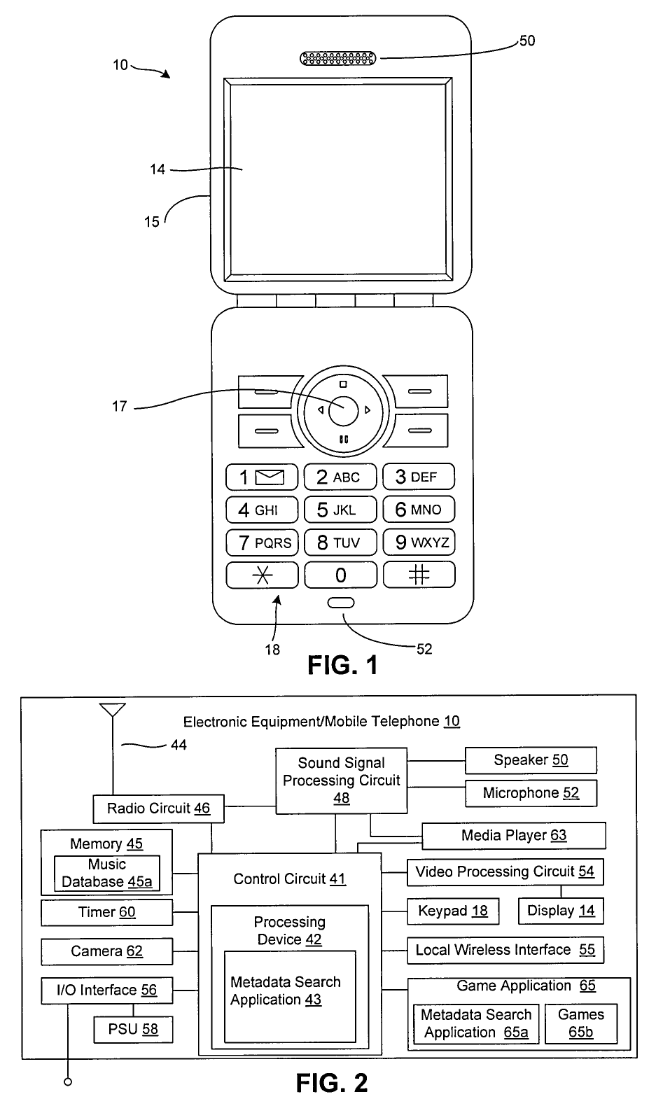

FIG. 1 depicts an exemplary mobile telephone 10. Mobile telephone 10 may be a clamshell phone with a flip-open cover 15 movable between an open and a closed position. In FIG. 1, the cover is shown in the open position. It will be appreciated that mobile telephone 10 may have other configurations, such as a “block” or “brick” configuration.

FIG. 2 represents a functional block diagram of the mobile telephone 10. The mobile telephone 10 may include a metadata search application 43 for carrying out the features of the invention. Application 43 may be embodied as executable program code that is resident in and executed by the mobile telephone 10. The mobile telephone 10 may include a controller that executes the program code stored on a computer or machine-readable medium. The controller may include a control circuit 41 and/or a processing device 42. The program may be a stand-alone software application or form a part of a software application that carries out additional tasks related to the mobile telephone 10.

Alternatively, mobile telephone 10 may include a game application 65, which contains the metadata search application 65a. Thus, the metadata search application may be embodied as part of an application program that may be executed by mobile telephone 10. Game application 65 may also contain games 65b embodied as executable code within the game application. The video game may be a stand-alone application (as shown in FIG. 2) or stored in a memory 45 within the mobile telephone. Alternatively, the video game may be accessed and played from a server over the Internet or other communications network external to the mobile telephone.

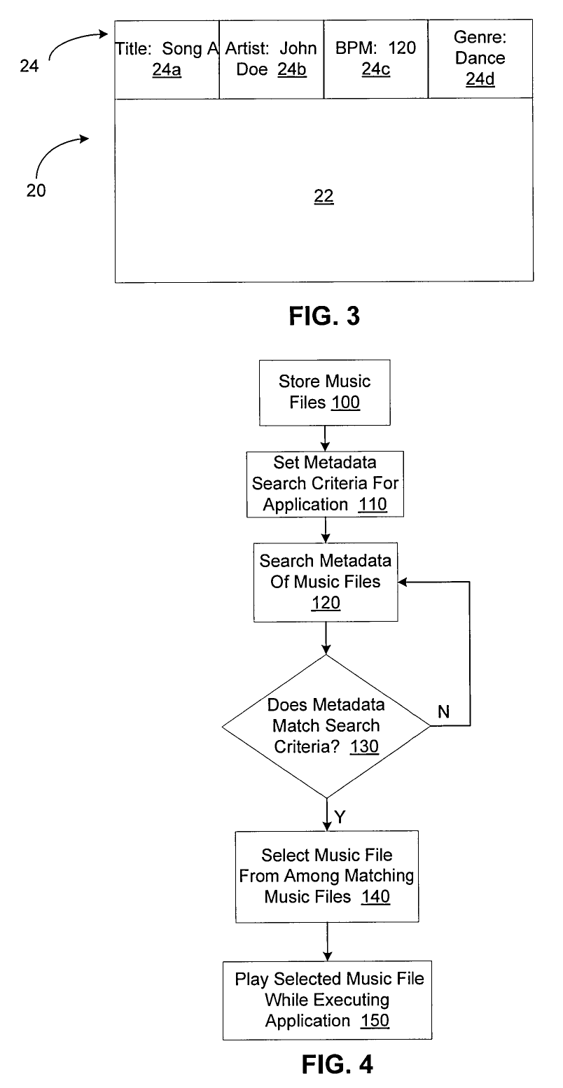

FIG. 3 is a schematic block diagram that represents the relevant portions of a typical music file 20. Music file 20 may be a single song, an excerpt of a song, or multiple songs. Music file 20 may include music portion 22, which may be thought of as the substantive music itself. Music portion 22 may be coded in one of a variety of digital music formats such as MIDI, MP3, or other formats as are known in the art. Music file 20 also may include associated metadata fields 24, which provide various items of information about the music. In the depicted example, the metadata includes four exemplary metadata fields: song title (24a), artist (24b) beats per minute (BPM) (24c), and genre (24d).

It will be appreciated that both the number and nature of the metadata fields may be varied. Some of the metadata, such as song title and artist, may be unalterable and set at the time the music file is created. In addition, with an appropriate program or application as is known in the art, metadata fields may be defined by the user. For example, a user may wish to add a “mood” identifier as part of the metadata to associate the music with a particular mood, such as a party or relax mood for example. A user also may wish to add a category identifier as part of the metadata to group music together, such as using metadata to create a “favorites” grouping of songs. Other examples of both automatic and user defined metadata fields may be employed.

A plurality of music files 20 may be downloaded and stored within a memory 45 within the mobile telephone 10. Alternatively, as further described below, music files may be streamed, either as recorded files or a live broadcast feed, to the mobile telephone from a server on a communications network.

A media player 63 within the mobile telephone may be used to a play a music file stored in memory or streamed over a network. Although the music may be played and enjoyed by itself, embodiments of the present invention permit a user to select music to be incorporated with or into non-music applications. By permitting a user to incorporate customized music into non-music applications, enjoyment of the other applications is enhanced.

FIG. 4 depicts an exemplary method of incorporating music into a non-music application in accordance with an embodiment of the present invention. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

By way of example, the method of FIG. 4 will be described in connection with incorporating music into a video game playable on the mobile telephone 10. It will be appreciated that the video game example is not intended to limit the scope of the invention, and a similar method may be used to incorporate user selected music into other non-music applications. In addition, a similar method may be employed with electronic devices other than a mobile telephone, such as, for example, personal desktop or laptop computers, PDAs, portable gaming devices, and the like.

The method begins at step 100, in which a plurality of music files containing metadata may be stored in a storage device as a music library or database. In the currently described embodiment, it is assumed that the storage device for the music library is a music database 45a within the memory 45 of the mobile telephone.

At step 110, metadata search criteria for a device application are set. The search criteria are configured to match appropriate music to the device application based on the nature of the application. To search for an appropriate match, the search criteria may incorporate multiple metadata fields.

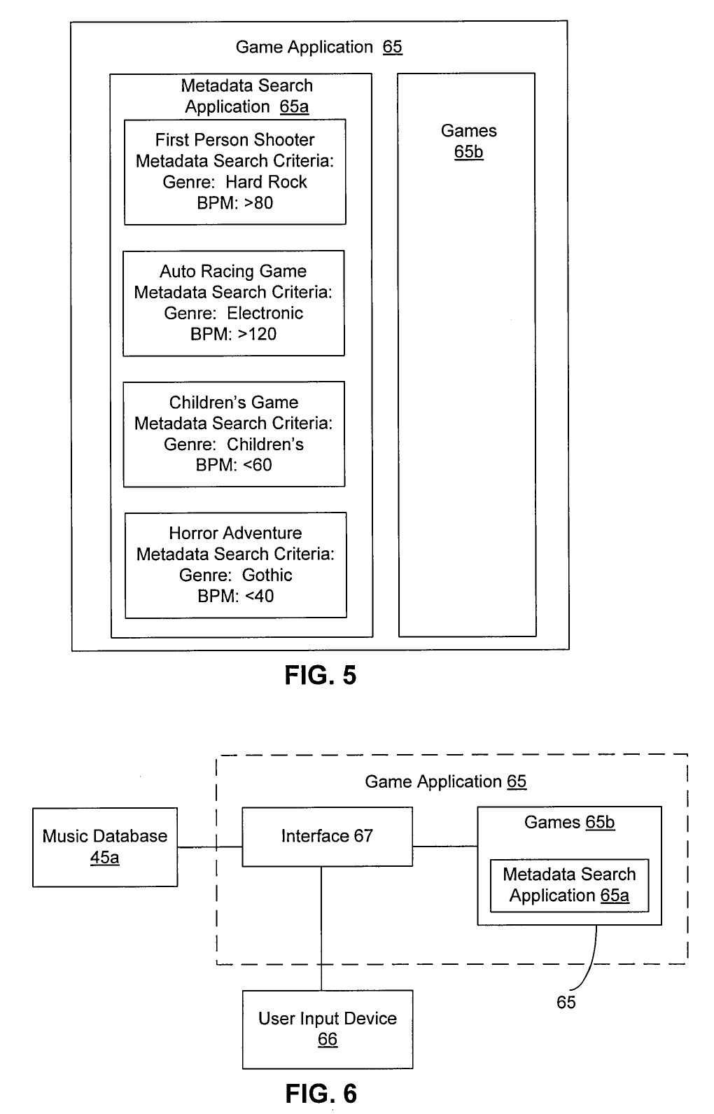

FIG. 5 is a schematic diagram of an exemplary game application 65 that may be employed in accordance with the present invention. In one embodiment, the metadata search criteria are set within the game application 65. Game application 65 may include games 65b which are the substantive gaming programs. The games may include one or more games from a variety of game genres. Game application 65 also may include the metadata search application 65a that sets the metadata search criteria. For example, a video game may be a first person shooter (FPS) in which the action level is high and nearly continuous. Appropriate music to incorporate into this type of video game may include music from the hard rock genre with a high beats per minute (BPM) above a certain numerical threshold (80 in the FIG. 5). In contrast, appropriate music to incorporate into a children's game may include music from a children's genre with a low BPM below a certain threshold (60 in FIG. 5). Other examples of search criteria may include a fast-paced driving game for which the metadata search criteria may include dance music having a BPM of at least 120, or a horror game for which the metadata search criteria may include gothic music having a BPM below 40. It will appreciated that other game categories with other metadata search criteria may be employed

The metadata search criteria may be set in whole or in part by the game developer as part of the process of developing the game program. In this embodiment, the search criteria are integral to the game. Alternatively or additionally, the user may set search criteria by inputting search criteria into the mobile telephone, whether as prompted by the game program or otherwise.

FIG. 6 depicts an embodiment in which the user may enter his or her own metadata search criteria. A user may input the metadata search criteria using an input device 66, which may be, for example, a keypad 18 (see FIGS. 1 and 2) or other input device on the mobile telephone 10. The input device 66 is linked to the game application 65 through an interface 67. As shown in the dashed lines of FIG. 6, the interface may be embodied as part of the game application itself, or it may be separate from the game application as part of the mobile telephone 10.

Developer and user search criteria may be combined to provide a balance between effort and user customization. For example, for an FPS game the game developer may program into the game general metadata search criteria, such as the hard rock genre and high BPM. The user may then input additional search criteria to provide customization. For example, the user may narrow the metadata search criteria to songs from a particular favorites list, or by a particular artist.

Referring again to FIG. 4, at step 120, the metadata search application may search the metadata of the plurality of music files in accordance with the search criteria. As stated above, the metadata search application may be embodied as code stored in the mobile telephone 10 (application 43), or it may be incorporated into a device application program, such as the video game application 65 (application 65a). FIGS. 5 and 6 depict an exemplary embodiment in which the metadata search application 65a is part of the game application 65. Metadata search application 65a may access the music database 45a stored with the mobile telephone through the interface 67. The metadata search application may search the metadata of the stored music files for metadata that matches the search criteria.

Thus, referring again to the method of FIG. 4, at step 130 the metadata of the stored music files may be compared to the search criteria to identify matching music that may be appropriate to the style of play of the video game. The metadata search application 65a may continue to search the metadata of the music files until the music library is exhausted. The search may identify more than one music file that matches the search criteria. At step 140, therefore, at least one music file from the matching music files may be selected to be incorporated into the application. The matching music may be selected automatically by the game application, or may be selected by the user with input device 66. Depending upon the length of the application, the game application and/or user may select multiple music files to play serially, or select one or more music files that will repeat as necessary. At step 150, when the application is executed, the selected music is accessed from the music database over the interface 67, and incorporated into the game application 65. In other words, the selected music may be played while the user is playing the video game.

Commonly, device applications may be divided into more than one component. For example, a video game may be divided into levels, chapters, or comparable component sections. The game play of the various components may differ in pace, mood, and other game play characteristics. For example, some components may employ game play dominated by fast-paced action, while other components may employ game play devoted to puzzle solving or more slow-paced play. In one embodiment, the method of FIG. 4 may be performed individually with respect to each level, chapter, or component of a video game (or other application). The music may be selected for the entire game at the beginning, or the user may be prompted to select music for each component as a given component is reached in the game. In this manner, the user may customize the music to provide music appropriate for each component.

The user also may alter or select different music each time the game is played, or change the music selections during the game. Therefore, the user may update the music as entertainers create new music, as the user's tastes change, to accommodate the tastes of multiple users, or otherwise.

In some of the embodiments described above, the music library and metadata search application were contained within the mobile telephone 10. Alternatively, one or more components of the system may be located external to the mobile telephone as part of a communications network.

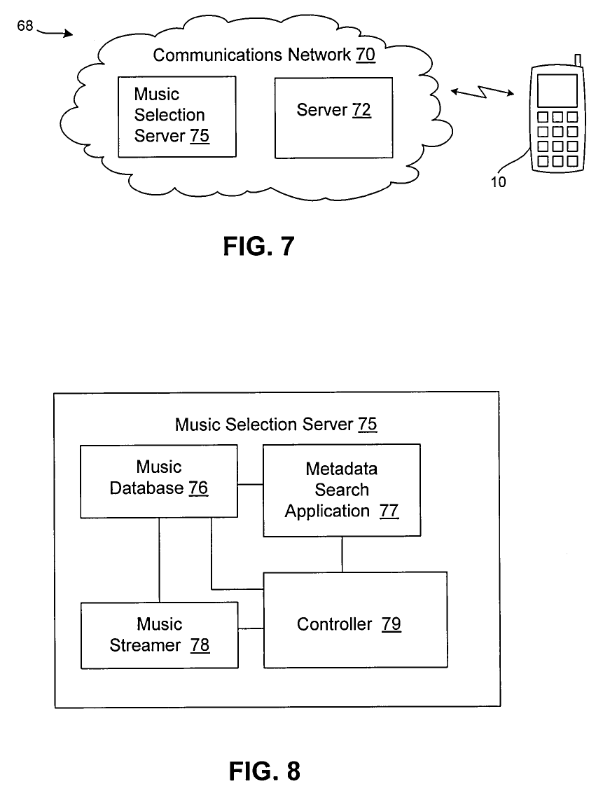

Referring to FIG. 7, the mobile telephone 10 may be configured to operate as part of a communications system 68. The system 68 may include a communications network 70 having a server 72 (or servers) for managing calls placed by and destined to the mobile telephone 10, transmitting data to the mobile telephone 10 and carrying out any other support functions. The server 72 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 70 may support the communications activity of multiple mobile telephones 10 and other types of end user devices. As will be appreciated, the server 72 may be configured as a typical computer system used to carry out server functions and may include a processor configured to execute software containing logical instructions that embody the functions of the server 72 and a memory to store such software.

Communications network 70 also may contain a music selection server 75 for use in accordance with embodiments of the present invention. FIG. 8 represents a functional block diagram of the components of an exemplary music selection server 75. The music selection server 75 may include a music database 76 for storing a plurality of music files. Similar to previous embodiments, the music files stored in the music database 76 contain associated metadata as described above. The music selection server also may include a controller 79 for carrying out and coordinating the various functions of the server. Music selection server 75 also may include a metadata search application 77.

The music selection server 75 (and its constituent components) may operate independent of or in tandem with comparable components of the mobile telephone 10. When operating independently, the music selection server essentially may perform the method of FIG. 4 to incorporate music into a non-music device application. At step 100, music files may be stored in the music database 76. The music database may be a database created specifically for use with the present invention, or it may be any commercial service for downloading or streaming music. At step 110, the metadata search criteria are set by the user and/or device application comparably to the previous embodiments. At step 120, metadata search application 77 may search the metadata of the stored music files for metadata that matches the search criteria. Once matching music files are found at step 130, at step 140 one or more matching music files may be selected to incorporate into the non-music application. At step 150, the selected music may be played while the application is executed.

When the music is stored in the music database 76 on network 70, the music may be incorporated into the device application by a variety of means. For example, the music files may be downloaded to the mobile telephone and stored in the memory 45. The device application may then access the stored music using media player 63 or otherwise. Alternatively, a music streamer 78 within the music selection server 75 may stream the music files to the mobile telephone as the device application is executed.

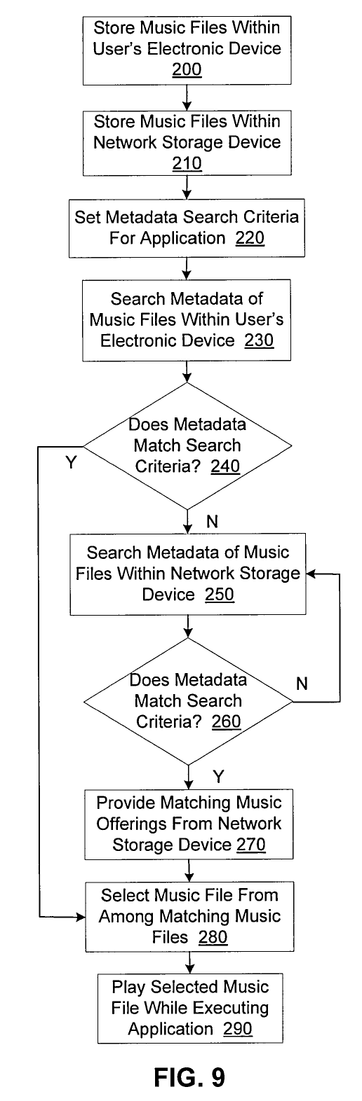

FIG. 9 depicts another exemplary method of incorporating music into a non-music application in accordance with an embodiment of the present invention. The method of FIG. 9 employs components of music selection server 75 and mobile telephone 10 to incorporate music into non-music applications. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

At step 200, music files may be stored within a user's electronic device in a first storage device, such as the memory 45 of the mobile telephone 10. At step 210, additional music files may be stored on a second, network storage device, such as the music database 76 of the music selection server 75. At step 220, metadata search criteria are set by the user and/or the device application as in previous embodiments. The music files stored with the mobile telephone 10 may then be searched by a metadata search application. The metadata search application may be resident in the mobile telephone as application 43, on the network as application 77, or embedded within the device application program (such as a video game) as application 65a.

At step 240, the metadata of the music files stored within the mobile telephone may be compared to the search criteria to identify matching music that may be appropriate to the device application. If the search criteria match the metadata of one or more music files stored in the first storage device within the mobile telephone, then the method may proceed similar to the method of FIG. 4. At step 280, one or more music files may be selected from among the matching music files for incorporating into the device application, such as a video game. At step 290, the selected music file may be played while the device application is executed.

At step 240, if the search criteria do not match the metadata of any music file stored on the mobile telephone, then the method may proceed to step 250. A search may be performed of the metadata of the music files stored within a second storage device on the network. At step 260, the metadata may be compared to the search criteria to identify matching music stored on the network storage device that may be appropriate to the device application. Once one or more network music files are identified whose metadata matches the search criteria, at step 270 the system may offer matching music files to the user. The music offerings may be in the form of music download offerings or streaming music offerings. At step 280, the user may select one or more matching music files, which then may be incorporated in the device application at step 290.

In one embodiment, the system of the present invention may constitute a subscription service for incorporating music into non-music applications. For example, a user may pay a fee for each downloaded music file. The music files may be protected with conventional Digital Rights Management (DRM) features, as is known in the art, to reduce the opportunity for copyright violations and ensure that the music is played only with the associated device application. A user may pay a subscription fee for unlimited access to the service, such as a monthly fee. If the music is streamed, the user may pay a fee per time of usage, such as per minute.

The storage space in certain electronic devices, such as mobile telephones and other portable electronic devices, may be limited because of their small size. In one alternative embodiment, to conserve storage space, only the metadata 24 is stored in memory, and not the substantive music portions 22 (see FIG. 3) of the music files. When the metadata search locates matching metadata, a user may then be directed to a service on a network that links particular metadata to corresponding music, such as the CDDB or GraceNotes mentioned above. The matching music may then be downloaded or streamed from the network for incorporation into the non-music application.

Referring again to FIG. 2, additional features of the mobile telephone 10 will now be described. For the sake of brevity, generally conventional features of the mobile telephone 10 will not be described in great detail herein. The mobile telephone 10 includes call circuitry that enables the mobile telephone 10 to establish a call and/or exchange signals with a called/calling device, typically another mobile telephone or landline telephone, or another electronic device. The mobile telephone 10 also may be configured to transmit, receive, and/or process data such as text messages (e.g., colloquially referred to by some as “an SMS,” which stands for short message service), electronic mail messages, multimedia messages (e.g., colloquially referred to by some as “an MMS,” which stands for multimedia message service), image files, video files, audio files, ring tones, streaming audio, streaming video, data feeds (including podcasts) and so forth. Processing such data may include storing the data in the memory 45, executing applications to allow user interaction with data, displaying video and/or image content associated with the data, outputting audio sounds associated with the data and so forth.

The mobile telephone 10 may include a primary control circuit 41 that is configured to carry out overall control of the functions and operations of the mobile telephone 10. The control circuit 41 may include a processing device 42, such as a CPU, microcontroller or microprocessor. Among their functions, to implement the features of the present invention, the control circuit 41 and/or processing device 42 may comprise a controller that may execute program code embodied as the metadata search application 43. It will be apparent to a person having ordinary skill in the art of computer programming, and specifically in application programming for cameras, mobile telephones or other electronic devices, how to program a mobile telephone to operate and carry out logical functions associated with application 43. Accordingly, details as to specific programming code have been left out for the sake of brevity. Also, while the code may be executed by control circuit 41 in accordance with an exemplary embodiment, such controller functionality could also be carried out via dedicated hardware, firmware, software, or combinations thereof, without departing from the scope of the invention.

Mobile telephone 10 has a display 14 viewable when the clamshell telephone is in the open position. The display 14 displays information to a user regarding the various features and operating state of the mobile telephone 10, and displays visual content received by the mobile telephone 10 and/or retrieved from the memory 45 Also, the display 14 may be used as an electronic viewfinder for a camera assembly 62.

A keypad 18 provides for a variety of user input operations. For example, keypad 18 typically includes alphanumeric keys for allowing entry of alphanumeric information such as telephone numbers, phone lists, contact information, notes, etc. In addition, keypad 18 typically includes special function keys 17 such as a “send” key for initiating or answering a call, and others. Some or all of the keys may be used in conjunction with the display as soft keys. Keys or key-like functionality also may be embodied as a touch screen associated with the display 14.

The mobile telephone 10 may include an antenna 44 coupled to a radio circuit 46. The radio circuit 46 includes a radio frequency transmitter and receiver for transmitting and receiving signals via the antenna 44 as is conventional. The mobile telephone 10 further includes a sound signal processing circuit 48 for processing audio signals transmitted by and received from the radio circuit 46. Coupled to the sound processing circuit 48 are a speaker 50 and microphone 52 that enable a user to listen and speak via the mobile telephone 10 as is conventional.

The display 14 may be coupled to the control circuit 41 by a video processing circuit 54 that converts video data to a video signal used to drive the various displays. The video processing circuit 54 may include any appropriate buffers, decoders, video data processors and so forth. The video data may be generated by the control circuit 41, retrieved from a video file that is stored in the memory 45, derived from an incoming video data stream received by the radio circuit 48 or obtained by any other suitable method.

The mobile telephone 10 also may include a local wireless interface 66, such as an infrared transceiver and/or an RF adaptor (e.g., a Bluetooth adapter), for establishing communication with an accessory, another mobile radio terminal, a computer or another device. For example, the local wireless interface 66 may operatively couple the mobile telephone 10 to a headset assembly (e.g., a PHF device) in an embodiment where the headset assembly has a corresponding wireless interface.

The mobile telephone 10 also may include an I/O interface 56 that permits connection to a variety of I/O conventional I/O devices. One such device is a power charger that can be used to charge an internal power supply unit (PSU) 58.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A system for selecting music for use in an electronic device comprising:
a media player within the electronic device;
a storage device for storing a plurality of music files, wherein each of the music files has associated metadata; and
a controller for executing an application by the electronic device, wherein the controller is configured to search the metadata of the music files for metadata that matches search criteria for selecting music to play during execution of the application; and
wherein the controller is further configured to cause the media player to play at least one music file for which the associated metadata matches the search criteria while executing the application.

2. The system according to claim 1, wherein the storage device is memory located within the electronic device.

3. The system according to claim 1, wherein the storage device is a server external to the electronic device.

4. The system according to claim 1, wherein the controller is within the electronic device.

5. The system according to claim 1, wherein the controller is within a server external to the electronic device.

6. The system according to claim 1, wherein the device application is a video game.

7. The system according to claim 1, wherein the search criteria for searching the music metadata include at least one of the song title, artist, beats per minute, genre, or mood.

8. The system according to claim 1, wherein the electronic device is a mobile telephone.

9. A method of using music in an application of an electronic device comprising the steps of:
storing a plurality of music files in a storage device, wherein each of the music files has associated metadata;
setting search criteria for searching the music metadata to select music for playing during execution of the application;
searching the music metadata of the plurality of music files to select at least one music file for which the associated metadata matches the search criteria; and
executing the application, wherein a music file for which the associated metadata matches the search criteria is played while the application is executed.

10. The method according to claim 9, wherein the storing step includes storing a first plurality of music files within a first storage device located within the electronic device, and the searching step includes searching the music metadata of the first plurality of music files to select at least one music file for which the associated metadata matches the search criteria.

11. The method according to claim 10, wherein the storing step includes storing a second plurality of music files within a second storage device located external to the electronic device, and the searching step includes, if a matching music file is not selected from the first storage device, searching the second plurality of music files on the second storage device to select at least one music file for which the associated metadata matches the search criteria.

12. The method according to claim 11, further comprising downloading the at least one matching music file from the second storage device to the electronic device.

13. The method according to claim 11, further comprising streaming the at least one matching music file from the second storage device to the electronic device.

14. The method of claim 9, wherein the application includes a plurality of components, and the method of claim 9 is performed as to each of the plurality of components.

15. The method according to claim 9, wherein the search criteria for searching the music metadata include at least one of song title, artist, beats per minute, genre, or mood.

16. The method according to claim 9, wherein the application is a video game.

17. The method according to claim 9, wherein the electronic device is a mobile telephone.
